(19) United States
(12) Patent Application Publication
(10) Pub. No.: US 2009/0071297 A1
(43) Pub. Date: Mar. 19, 2009

(54) Chainsaw Sharpening Tool

(76) Inventor: Jere F. Irwin, Yakima, WA (US)

Correspondence Address: WELLS ST. JOHN P.S., 601 W. FIRST AVENUE, SUITE 1300, SPOKANE, WA, 99201, US

(21) Appl. No.: 11/856,627

(22) Filed: Sep. 17, 2007

(51) Int. Cl. B23D 63/10

(52) U.S. Cl. 76/36; 407/29.13; 407/29.14; 407/29.15; 76/80.5

(57) ABSTRACT

A file guide is provided having a tubular handle, a spindle, and a retainer. The tubular handle has a central bore with an inner bearing surface and an outer gripping surface. The spindle has a cylindrical outer bearing surface configured to mate in complementary, rotatable relation with the inner bearing surface of the handle, a head at a proximal end, a lock portion at a distal end, and a central receptacle configured to receive a file shank. The retainer has an inner surface with a complementary lock portion configured to interlock with the lock portion of the spindle

### TECHNICAL FIELD

This invention pertains to chain saw sharpening apparatus. More particularly, the present invention relates to chain saw file guides and holders.

### BACKGROUND OF THE INVENTION

Round files have been used for sharpening teeth on chain saw blades. Such files are hand held which facilitates their use in the field. It is frequently necessary to sharpen teeth on a chain saw blade during field use as the blade can come into contact with the ground when cutting a felled tree which tends to quickly dull cutter teeth on the chain saw.

U.S. Pat. No. 3,327,567 is a round file guide and holder for sharpening chain saws. More particularly, the file holder has a clamp for holding a round file and a gauging surface that facilitates alignment and sharpening of individual teeth on a chain saw. A shank of the round file is held in a file handle while a handle portion is provided at an opposite end of the guide to facilitate longitudinal movement of the round file while sharpening individual teeth. However, the guide and file are hand held and the handle and handle portions do not rotate relative to the round file. Hence, the cutting action is not maximized and the file will have a tendency to clog relatively quickly.

U.S. Pat. No. 3,518,900 is another round file holder for sharpening chain saws. More particularly, the file holder has a longitudinally extending body with support members that hold a round file for rotation and a handle that fixes to an end of the file opposite the file shank. The handle is fixed onto the end of the file, enabling rotation of the file while a user longitudinally reciprocates the file holder and file to sharpen cutter teeth on a chain saw. However, the file is rotated by hand during the reciprocation process which is inefficient and not optimally effective.

U.S. Pat. No. 3,901,105 is a round file holder for sharpening chain saws. More particularly, the holder includes a hollow handle, an outer knob and a v-shaped guide bar that cooperate to support a round file at opposite ends. However, the handle and knob are each rigidly affixed to opposite ends of the file and do not rotate relative to the file. Accordingly, there is a limited ability to rotate the round file while longitudinally reciprocating the file to sharpen cutter teeth on a chain saw.

Accordingly, improvements are needed in the way a round file can be held and manipulated to sharpen cutter teeth on a chain saw, particularly when sharpening a chain saw in the field. Improvements are needed to increase the speed and effectiveness when sharpening individual cutter teeth due to the number of teeth present on a chain saw.

### SUMMARY OF THE INVENTION

A round file guide and holder are provided for more quickly and efficiently sharpening a chain saw, especially when the chain saw needs to be filed in the field while in use. The round file guide and holder facilitates use of a common hand tool, namely, a battery powered drill, to sharpen teeth on a chain saw.

According to one aspect, a file guide is provided having a tubular handle, a spindle, and a retainer. The tubular handle has a central bore with an inner bearing surface and an outer gripping surface. The spindle has a cylindrical outer bearing surface configured to mate in complementary, rotatable relation with the inner bearing surface of the handle, a head at a proximal end, a lock portion at a distal end, and a central receptacle configured to receive a file shank. The retainer has an inner surface with a complementary lock portion configured to interlock with the lock portion of the spindle.

According to another aspect, a chain saw file holder is provided having a handle, a spindle, and a fastener. The handle has a bore extending along a central axis providing an inner bearing surface. The spindle has a cylindrical outer bearing surface configured to mate with the inner bearing surface of the handle, a head at a proximal end, a first connector portion at a distal end, and a central receptacle configured to receive a file shank. The fastener has an inner surface with a complementary connector portion configured to interlock with the first connector portion of the spindle to retain the handle on the spindle for rotation.

According to yet another aspect, a chain saw file guide is provided having a tubular handle, a spindle and a connector. The tubular handle has a central bore with an inner bearing surface and an outer gripping surface. The spindle has a cylindrical outer bearing surface configured to mate in complementary, rotatable relation with the inner bearing surface of the handle, a head at a proximal end, a lock portion at a distal end, and a central receptacle configured to receive a file shank. The connector has an inner surface with a complementary lock portion configured to interlock with the lock portion of the spindle.

### BRIEF DESCRIPTION OF THE DRAWINGS

Preferred embodiments of the invention are described below with reference to the following accompanying drawings.

FIG. 1 is a perspective view of a round file holder and guide used in combination with a portable rotary driving device to sharpen individual cutters on a chainsaw, according to one embodiment of the invention.

FIG. 2 is an exploded perspective view of the round file guide of FIG. 1.

FIG. 3 is an exploded perspective view of a round file guide similar to that depicted in FIG. 2, according to another aspect of the invention.

FIG. 4 is an exploded perspective view of a round file guide similar to that depicted in FIG. 2, according to yet another aspect of the invention.

FIG. 5 is an enlarged perspective and partial exploded centerline sectional view of the round file guide of FIGS. 1-2.

FIG. 6 is a side elevational view of the round file guide of FIGS. 1-2 and 5.

FIG. 7 is a left end view relative to the view of FIG. 6.

FIG. 8 is a right end view relative to the view of FIG. 6.

FIG. 9 is an elevational centerline sectional view of a handle of the round file guide of FIGS. 1-2 and 5-8.

FIG. 10 is sectional view taken along line 10-10 of FIG. 9.

FIG. 11 is a centerline sectional view of a spindle of the round file guide of FIGS. 1-2 and 5-10.

FIG. 12 is a centerline sectional view of a retainer ring of the round file guide of FIGS. 1-2 and 5-11.

FIG. 13 is a centerline sectional view of the round file guide of FIGS. 1-2 and 5-12 loaded onto a shank end of a round file.

FIG. 14 is an enlarged centerline sectional view of the round file guide taken from the encircled region 14 of FIG. 13.

FIG. 15 is a plan view of the round file guide in use sharpening a left-facing cutter tooth of a chain saw.

FIG. 16 is a plan view of the round file guide in use sharpening a right-facing cutter tooth of a chain saw.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

Reference will now be made to preferred embodiments of Applicant's invention comprising a round file holder and guide for sharpening chain saws. While the invention is described by way of these preferred embodiments, it is understood that the description is not intended to limit the invention to such embodiments, but is intended to cover alternatives, equivalents, and modifications which may be broader than the embodiments, but which are included within the scope of the appended claims.

In an effort to prevent obscuring the invention at hand, only details germane to implementing the invention will be described in great detail, with presently understood peripheral details being incorporated by reference, as needed, as being presently understood in the art.

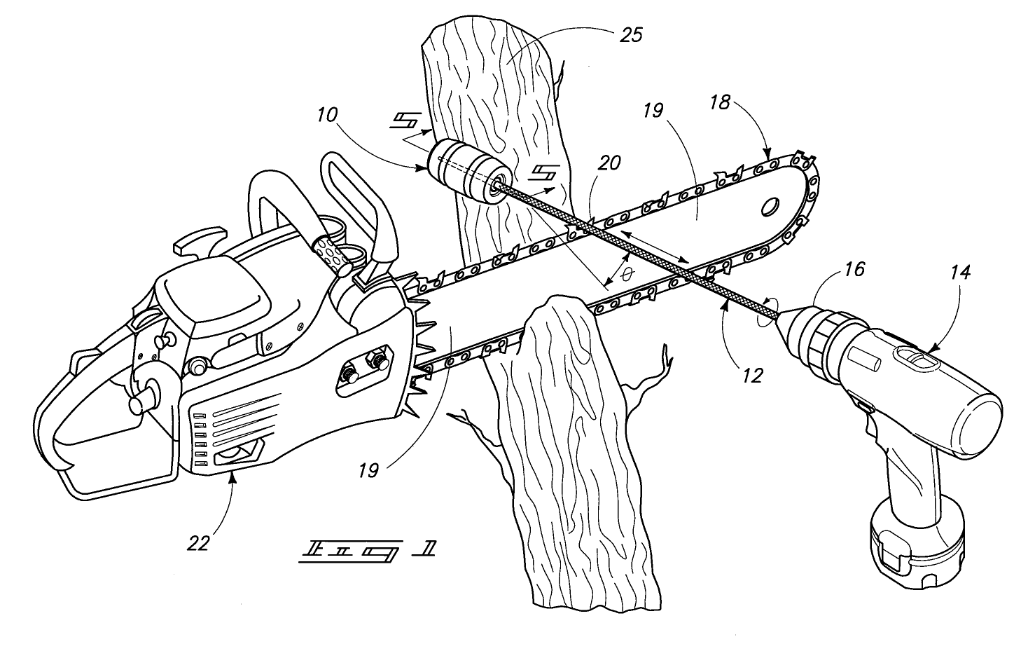

FIG. 1 illustrates a file guide and holder 10, according to one aspect of the present invention. File guide 10 is rigidly secured onto a shank end of a round file 12 while an opposite end of file 12 is captured in a chuck 16 of a portable power tool, such as a battery powered drill 14. File guide 10 is journalled for rotation so that an outer surface can be held stationary while an inner surface that is affixed to file 12 is rotated by drill 14. A user is then able to grasp file guide 10 with one hand while holding and operating drill 14 with another hand. In combination or alternately, file 12 is rotated and reciprocated in a longitudinal direction while being held at an optimal angle to sharpen individual cutter teeth 20 on a chain 18 for a chain saw 22. According to one sharpening technique, a bar 18 on chain saw 22 is placed into a pre-cut kerf in a log 25 to secure or retain chain 18 during sharpening in the field. This positioning holds teeth 20 stationary during sharpening.

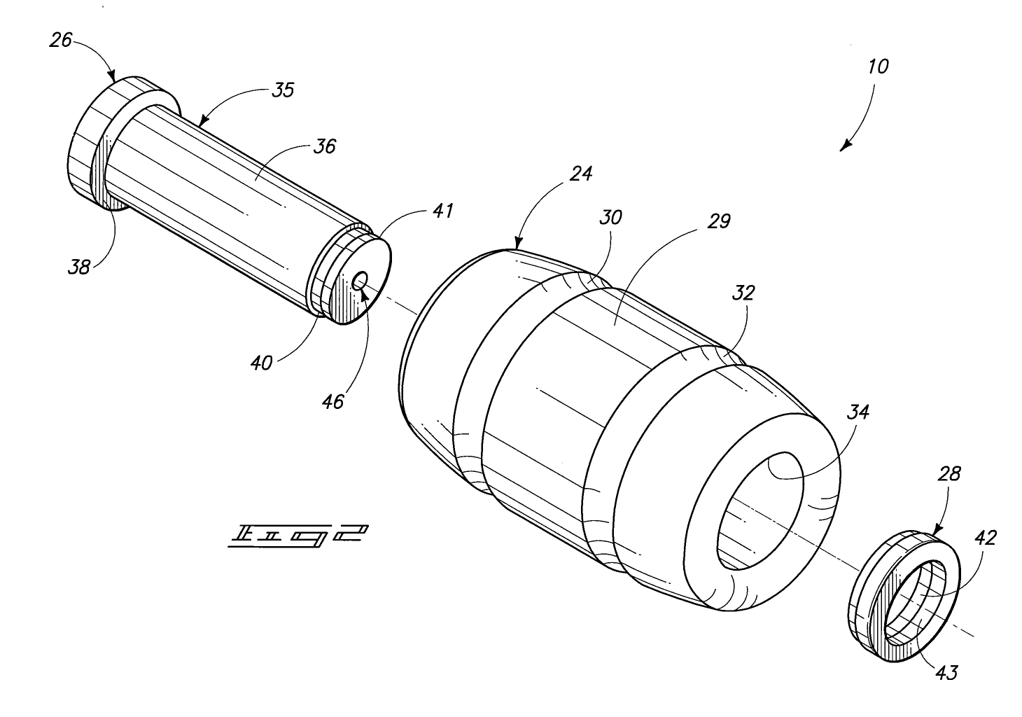

FIG. 2 illustrates one construction for file guide 10 in enlarged and exploded perspective view. File guide 10 includes a tubular handle 24, a spindle 26 and a retainer ring 28. Retainer ring 28 is locked onto a distal end of spindle 26 with a snap-fit connection that traps handle 24 for rotation atop spindle 26. A stepped through-bore 46 extends completely through spindle 26 for receiving and mounting a shank-end of a round file (see FIG. 1). Optionally, bore 46 can terminate within spindle 26.

Tubular handle 24 has a barrel-shaped outer surface 29 with a pair of circumferential grooves 30 and 32 and an inner cylindrical bore 34 extending completely through handle 24. Alternatively, other geometrical shapes can be provided for surface 29 such as tubular shapes, cylindrical shapes, hand-conforming ergonomic shapes or any shape suitable to be gripped by a user's hand. According to one construction, tubular handle 24 is formed from aluminum alloy. However, other materials can be used such as plastics, composites, wood, metals or other suitable structural materials.

Spindle 26 has a cylindrical shaft 35 and an enlarged cylindrical head 38 formed integrally with shaft 35. According to this construction, stepped bore 46 extends completely through spindle 26. Shaft 35 provides a cylindrical outer bearing surface 36 configured to mate in complementary rotational relation with cylindrical bearing surface 34 of handle 24. Head 38 is provided on a proximal end of shaft 35, while a cylindrical groove, or reduced diameter portion 40 and an enlarged cylindrical end flange, or increased diameter portion 41 are provided on a distal end of shaft 35. According to one construction, spindle 26 is constructed from Nylatron®, a molybdenum disulfide (MDS) filled wear-resistant nylon available from The Polymer Corporation of Reading, Pa. Optionally, spindle 26 can be formed from any suitable structural material such as plastic, reinforced plastic, wood, composites, metal or any suitable structural material.

Retainer ring 28 comprises a cylindrical body having a reduced diameter inner bore 42 and an increased diameter inner bore 43 adjacent thereto. In assembly, bore 43 receives end flange 41 of spindle 26, whereas bore 42 mates with groove 41, thereby trapping ring 28 onto spindle 26. According to one construction, ring 28 is constructed from Nylatron®. Optionally, ring 28 can be formed from any suitable structural material such as plastic, reinforced plastic, wood, composite, metal or any suitable structural material. Optionally, ring 28 can be constructed in multiple pieces, such as a retaining flange and a separate fastener, such as a snap-ring or other suitable fastener.

FIG. 3 is an optionally-constructed file guide 110, similar to file guide 10 depicted in FIG. 2. More particularly, file guide 110 includes an optionally-constructed tubular handle 124 that is mated between a spindle 26 that is identical to spindle 26 in FIG. 2 and a retainer ring 128 that is substantially similar to retainer ring 28 in FIG. 2.

Tubular handle 124 differs from handle 24 in FIG. 2 in that an outer surface 129 is provided with a knurled surface 130 that is machined into outer surface 129. Knurled surface 130 provides a grip portion on outer surface 129 of handle 124. Retainer ring 128 has a slightly different tapered surface than does ring 28 (of FIG. 2).

Spindle 26 includes cylindrical shaft 35 and head 38 that are formed from a single piece of material. Shaft 35 provides a cylindrical bearing surface 36 that terminates in a groove, or reduced diameter portion 40 and a cylindrical end flange, or increased diameter portion 41. A receptacle 46 extends completely through spindle 26, between opposite ends, for receiving the shank of a file (not shown). In assembly, retainer ring 128 is snap-fit onto spindle 26, over flange 41 and into groove 40, so as to trap tubular handle 124 therebetween for rotation atop cylindrical bearing surface 36.

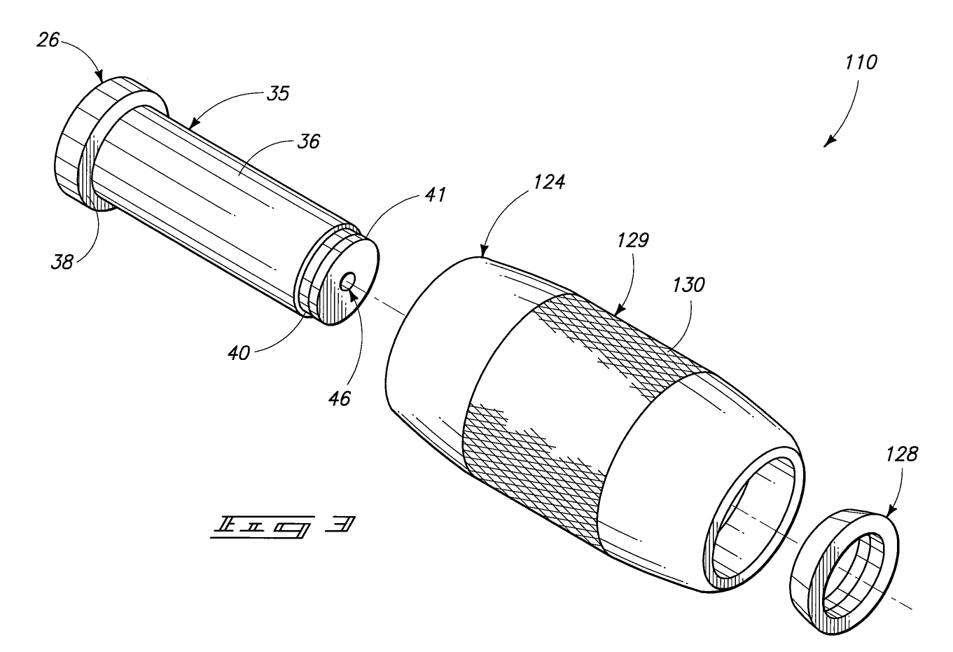

FIG. 4 is a second optional configuration file guide 110, similar to file guide 10 depicted in FIG. 2. More particularly, file guide 110 includes another optionally-constructed tubular handle 224 that is mated between a spindle 26 that is identical to spindle 26 in FIG. 2 and a retainer ring 228 that is substantially similar to retainer ring 28 in FIG. 2.

Tubular handle 224 differs from handle 24 in FIG. 2 and handle 124 in FIG. 3 in that an outer surface 229 is provided with an alternating array of diagonal grooves 230 and 232 which are spaced at alternating angles representing the ideal cutting angle for a round file that has been secured within shank 26. Grooves 230 and 232 are machined into outer surface 229 for the case where handle 224 is made from a machined piece of aluminum. Optionally, grooves or grip surface features can be molded into the handle for the optional case where the handle is made from a molded material.

Spindle 26 is the same as spindle 26 in the configurations of FIGS. 2 and 3. In assembly, retainer ring 228 is snap-fit onto spindle 26 so as to trap tubular handle 124 therebetween for rotation atop cylindrical bearing surface 36. Retainer ring 128 has a slightly different tapered surface than does ring 28 (of FIG. 2).

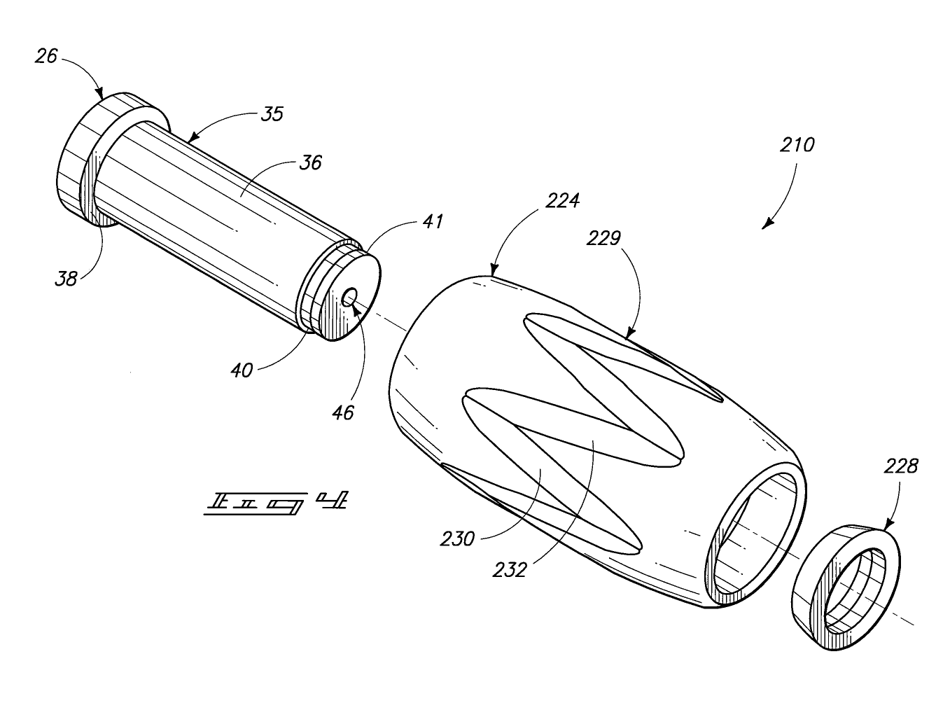

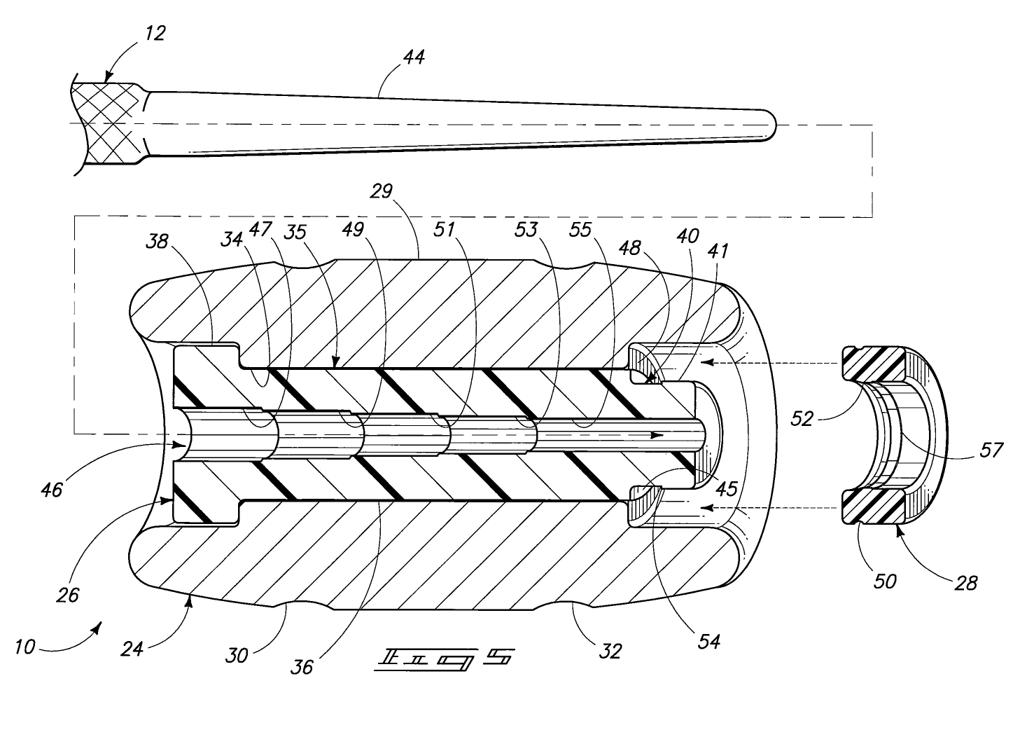

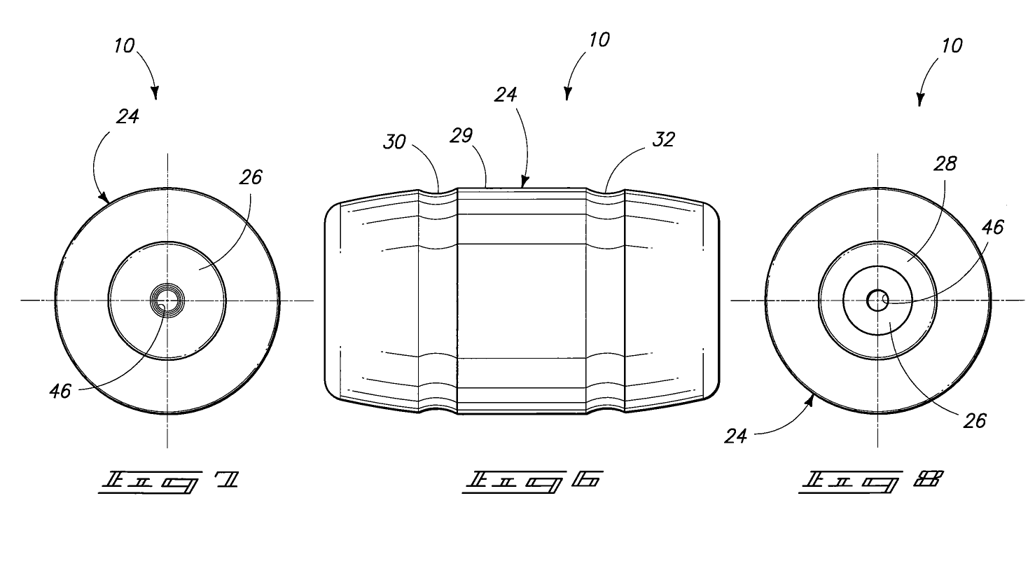

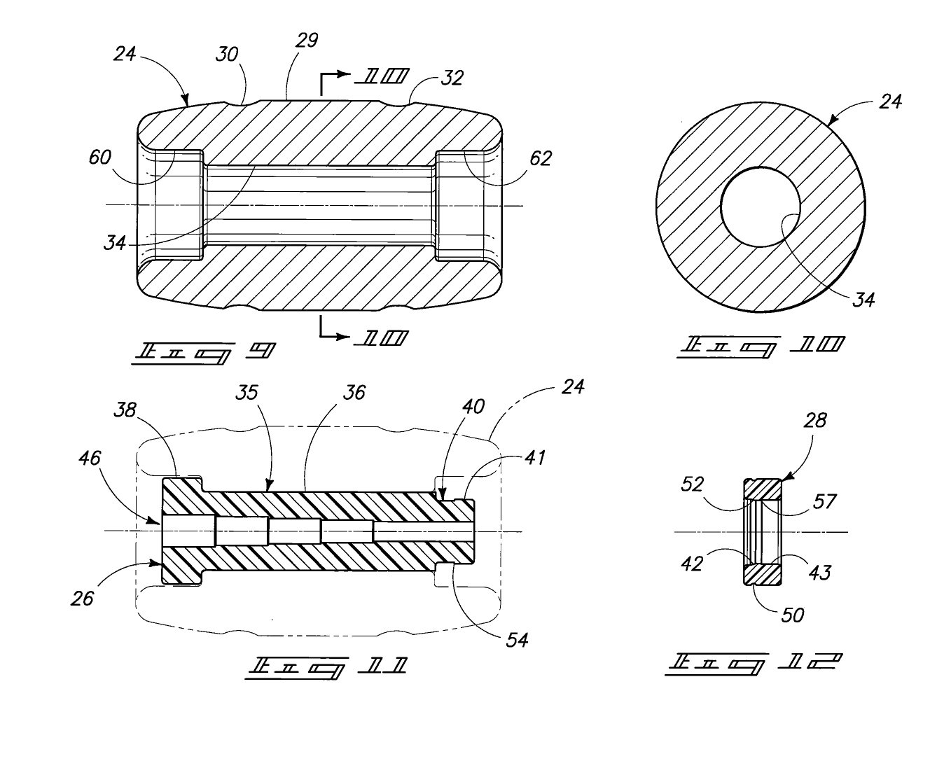

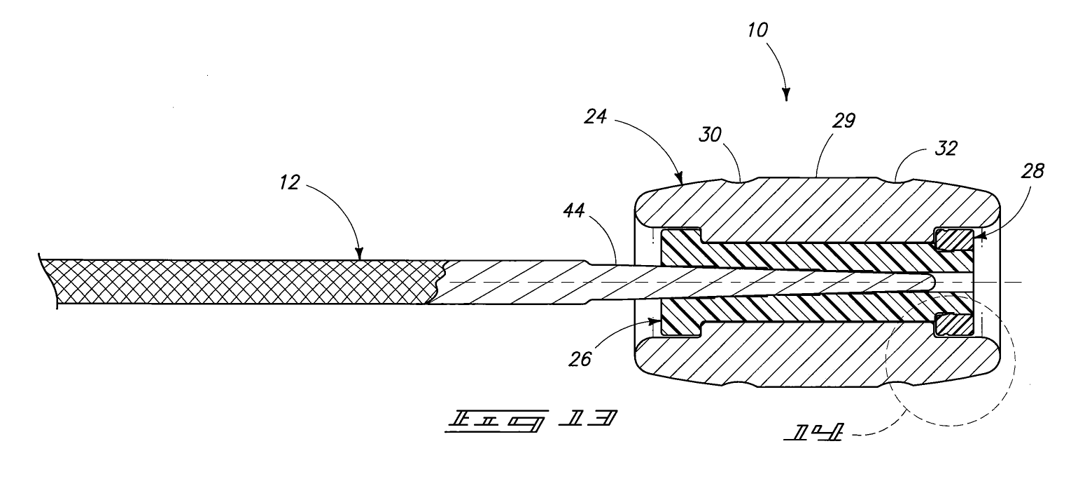

FIG. 5 illustrates in center line sectional view greater details of file guide 10 depicted in FIGS. 2 and 3. More particularly, a shank 44 on round file 12 is forcibly inserted into receptacle 46 of shank 26. In order to accommodate the tapered configuration of shank 44, receptacle 46 comprises a series of stepped-down diameter bores 47, 49, 51, 53 and 55 which progressively decrease in diameter extending in a direction from head 38 towards flange 41.

Typically, a shank 44 on a round file 12 has a rectangular cross-sectional configuration which provides edges that, when forcibly urged into receptacle 46, slightly deform the leading edge diameters of each progressive bore 47, 49, 51, 53 and 55, which ensures snug fixation of shank 44 within spindle 26. Hence, spindle 26 is caused to grip and thereby rotate with shank 44 of file 12.

Retainer ring 28 is forcibly urged over cylindrical end flange 41 on shank 26 until a tapered inner surface 52 and a lip edge 57 of ring 28 clears the radial lip edge 54 on the leading end of cylindrical end flange 41. During such assembly, ring 28 and shank 26 change in dimension until lip edges 54 and 57 clear, allowing such ring 28 and shank 26 to return to their former dimensions by their own natural resilience. Accordingly, lip edge 57 clears lip edge 54 during assembly such that tapered inner surface 52 on lip edge 54 is received within groove 40 on shank 26. Upon assembly, lip edge 57 overlaps with lip edge 54 to lock and retain ring 28 onto spindle 26. In assembly, retainer ring 28 seats against a cylindrical end surface 48 on handle 24, as well as a complementary end portion 45 on a shank 26. According to one construction, shank 26 and retainer ring 28 are machined from a single piece of a rigid, but somewhat resilient material, such as Nylatron®. Such a structurally stable yet reasonably resilient material enables tapered inner surface 52 and lip 57 to flex sufficiently along with end flange 41 to provide for forcible assembly and interlocking engagement of retainer ring 28 into groove 40.

Shank 44 of round file 12 is locked into receptacle 46 by tapping or forcibly urging shank 44 into receptacle 46. Subsequently, a distal end of round file 12 is inserted and locked into a chuck of a portable power drill, as depicted in FIG. 1. As was previously discussed in reference to the depiction in FIG. 1, a user then rotates the portable hand drill so as to cause file 12 to rotate along with shank 26 and retainer 28. Concurrently, a user's other hand is used to grip outer surface 29 on handle 24 so as to facilitate guiding round file 12 during a sharpening operation when sharpening teeth on a chainsaw.

Cylindrical grooves 30 and 32 facilitate visual alignment of round file 12 relative to individual cutter teeth on a chainsaw and relative to the chain saw bar. More particularly, grooves 30 and 32 give a visual indication of the orientation of the file relative to a chain saw. Cylindrical grooves 30 and 32 further facilitate gripping by a user's hand during manipulation of round file using a portable hand drill to sharpen a file. This is of particular importance because file 12 is being rotated at a relative high speed relative to file guide 10 and it would be undesirable for a user's hand to slip off guide 10 and onto file 12.

Cylindrical shaft portion 35 provides cylindrical bearing surface 36 which mates in engagement with cylindrical bearing surface 34 on shank 26. Surfaces 34 and 36 are sized in complementary relation and cooperate to provide a relatively low-friction bearing surface between handle 24 and spindle 26. A circumferential groove 50 on retainer ring 28 provides a relief for contaminants, such as dirt and wood particles, that might work into and between retainer ring 28 and handle 24.

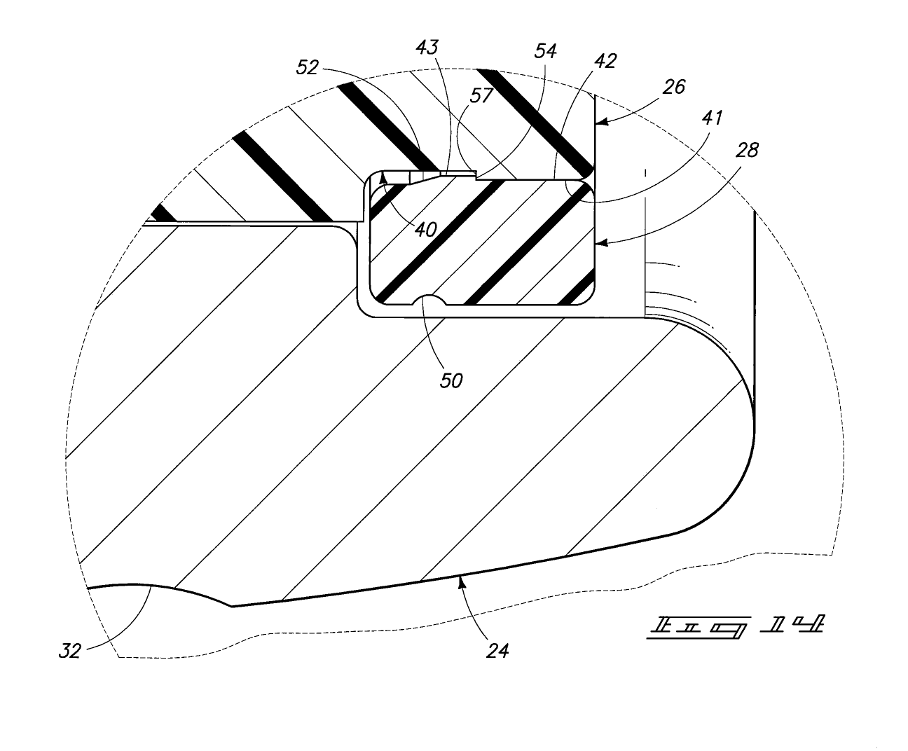

FIG. 13 illustrates a typical round file 12 mounted onto file guide 10 as typically configured when an opposite end of round file 12 has been locked into a chuck of a portable hand drill (not shown). In some cases, it may be better to secure file guide 10 onto shank 44 prior to inserting the opposite end of round file 12 into a drill chuck. According to such an assembly, shank 44 of round file 12 can be tapped into file guide 10 by inserting shank 14 into spindle 26 and forcibly striking an opposed end of file guide 10 onto a rigid surface, such as a tabletop. Such action will drive shank 44 of round file 12 rigidly and snugly into urgable engagement within spindle 26.

In operation, a user holds a portable power tool, such as a battery powered drill in one hand while the user holds file guide 10 in the opposite hand, thereby gripping an outer surface 29 and grooves 30 and 32 on handle 24. Upon application of power to the hand drill, spindle 26 and retainer ring 28 rotate with round file 12 while handle 24 remains secured in a user's hand, thereby preventing rotation. Accordingly, relative rotation occurs between spindle 26, retainer ring 28 and handle 24.

FIG. 14 further illustrates the attachment between retainer ring 28 and spindle 26. Tapered inner surface 52 on retainer ring 28 is forcibly urged over end flange 41, during assembly, until radial lip edge 54 clears end flange 41 and seats within circumferential groove 40 which has a smaller diameter than does end flange 41. Accordingly, upon assembly radial lip edge 54 locks retainer ring 28 onto spindle 26. Once locked together, a reduced diameter inner surface 42 on retainer ring 28 is seated within groove 40, while an increased diameter inner surface lip 43 is seated alongside end flange 41. Furthermore, lip edge 57 on spindle 26 engages with lip edge 54 on retaining ring 28 to lock retaining ring 28 onto spindle 26. Preferably, there is a slight gap between retaining ring 28 and handle 24, and circumferential groove 50 serves to provide a reservoir for any contaminants that might otherwise lodge between retaining ring 28 and handle 24 during use. The purpose of groove 50 to retain debris is important in that relative rotation occurs between spindle 26, retaining ring 28 and end handle 24 and such contaminants would contribute to friction and undue wear.

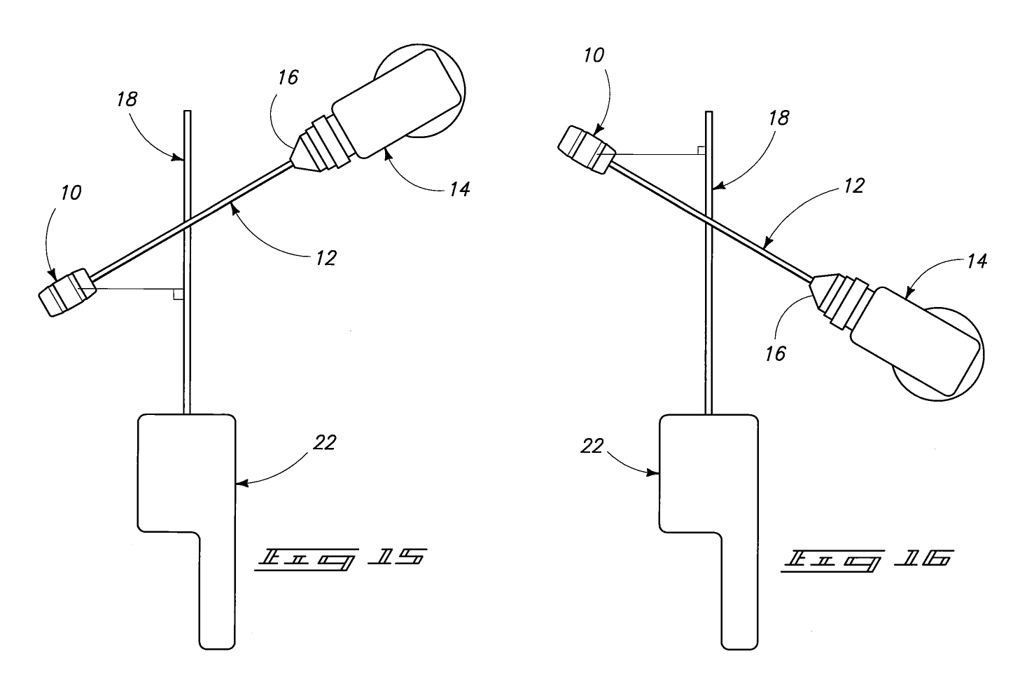

FIGS. 15 and 16 illustrate alternate positions for a battery powered hand drill 14, a round file 12 and file guide 10 when sharpening alternating left and right cutter teeth on a chain 18 of a chainsaw 22. According to the orientation shown in FIG. 15, a left-facing gullet on one cutter tooth is being sharpened by placing round file 12 at an appropriate angle relative to the bar on chainsaw 22 while round file 12 is securely locked into a chuck 16 on drill 14. A user operates drill 14 with one hand while grasping and holding file guide 10 at a desired location so as to present round file 12 at a proper angular orientation for sharpening the left facing cutter tooth on chain 18.

As shown in FIG. 16, a user positions drill 14, round file 12, and file guide 10 in an opposite orientation in order to sharpen a right-facing gullet on a cutter tooth on chain 18 of chainsaw 22.

According to the configurations depicted in FIGS. 15 and 16, a user can rotate round file 12 while simultaneously longitudinally oscillating round file 12 while pressed into engagement within a gullet of a cutter tooth on chain 18. This action helps clear the file teeth of debris and further increases rotational shear action between the file teeth and the cutter teeth being sharpened which enhances cutting and sharpening of the cutter teeth. It is understood that a user will alternate between the configurations depicted in FIGS. 15 and 16 when sharpening a chainsaw as alternating teeth are typically left and right facing along chain 18.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A file guide, comprising:
a tubular handle having a central bore with an inner bearing surface and an outer gripping surface;
a spindle having a cylindrical outer bearing surface configured to mate in complementary, rotatable relation with the inner bearing surface of the handle, a head at a proximal end, a lock portion at a distal end, and a central receptacle configured to receive a file shank; and
a retainer having an inner surface with a complementary lock portion configured to interlock with the lock portion of the spindle.

2. The file guide of claim 1, wherein the spindle lock portion comprises a first cylindrical portion with a first diameter and a second cylindrical portion with a second diameter greater than the first diameter.

3. The file guide of claim 2, wherein the first cylindrical portion is at a distal end of the cylindrical outer bearing surface and the first cylindrical portion has a diameter that is less than a diameter of the cylindrical outer bearing surface.

4. The file guide of claim 3, wherein the first cylindrical portion is stepped down in diameter relative to the cylindrical outer bearing surface.

5. The file guide of claim 4, wherein the second cylindrical portion is stepped up in diameter relative to the first cylindrical portion.

6. The file guide of claim 1, wherein the handle gripping surface comprises a plurality of grooves configured to demarcate angular alignment with a saw blade on a saw bar in order to align a file cutting surface of a round file with a selected tooth on the saw blade.

7. The file guide of claim 1, wherein at least one of the inner bearing surface and the outer bearing surface comprises a relatively low friction material.

8. The file guide of claim 1, wherein the retainer comprises a snap-fit ring configured to couple with the spindle.

9. The file guide of claim 8, wherein the snap-fit ring comprises a beveled leading edge configured to override and engage via the complementary lock portion with the lock portion of the spindle.

10. The file guide of claim 1, wherein the tubular handle comprises a cylindrical handle, and the spindle is placed centrally of the cylindrical handle.

11. A chain saw file holder, comprising:
a handle having a bore extending along a central axis providing an inner bearing surface;
a spindle having a cylindrical outer bearing surface configured to mate with the inner bearing surface of the handle, a head at a proximal end, a first connector portion at a distal end, and a central receptacle configured to receive a file shank; and
a fastener having an inner surface with a complementary connector portion configured to interlock with the first connector portion of the spindle to retain the handle on the spindle for rotation.

12. The chain saw file holder of claim 11, wherein the handle comprises a cylindrical handle.

13. The chain saw file holder of claim 12, wherein the spindle is mounted coaxially within the cylindrical handle.

14. The chain saw file holder of claim 11, wherein the fastener comprises a snap-fit ring.

15. The chain saw file holder of claim 14, wherein the snap-fit ring comprises a beveled leading edge configured to override and engage via the complementary connector portion with the first connector portion of the spindle.

16. A chain saw file guide, comprising:
a tubular handle having a central bore with an inner bearing surface and an outer gripping surface;
a spindle having a cylindrical outer bearing surface configured to mate in complementary, rotatable relation with the inner bearing surface of the handle, a head at a proximal end, a lock portion at a distal end, and a central receptacle configured to receive a file shank; and
a connector having an inner surface with a complementary lock portion configured to interlock with the lock portion of the spindle.

17. The chain saw file guide of claim 16, wherein the connector comprises a snap-fit ring.

18. The chain saw file guide of claim 16, wherein the snap-fit ring comprises a beveled leading edge configured to override and engage via the complementary lock portion with the lock portion of the spindle.

19. The chain saw file guide of claim 16, wherein the handle gripping surface comprises a plurality of grooves configured to demarcate angular alignment with a saw blade on a saw bar in order to align a file cutting surface of a round file with a selected tooth on the saw blade.

20. The chain saw file guide of claim 19, wherein the grooves each comprise a circumferential groove.
